(19) United States
(12) Patent Application Publication
(10) Pub. No.: US 2018/0258618 A1
(43) Pub. Date: Sep. 13, 2018

(54) TOOL HAVING A HARD MATERIAL

(71) Applicant: Betek GmbH & Co. KG, Aichhalden (DE)

(72) Inventors: Ulrich Kraemer, Wolfach (DE); David Chmelik, Schramberg (DE)

(73) Assignee: Betek GmbH & Co. KG, Aichhalden (DE)

(21) Appl. No.: 15/969,036

(22) Filed: May 2, 2018

Related U.S. Application Data
(63) Continuation of application No. PCT/EP2016/075451, filed on Oct. 21, 2016.

(30) Foreign Application Priority Data
Nov. 6, 2015 (DE) 10 2015 119 123.7

(51) Int. Cl. E02F 9/28; E21C 35/183; A01B 33/10

(52) U.S. Cl. CPC E02F 9/285; E02F 9/2866; C01B 32/152; A01B 33/10; E21C 35/183

(57) ABSTRACT

The invention relates to a tool having a hard material for processing mineral and/or plant-based material layers, in particular of traffic areas and/or agricultural floor areas or combinations thereof with one another. According to the invention, at least one part of the cutting element is formed or covered with a hard material containing fullerite or formed from fullerite. The wear resistance of the tool can be significantly improved by the extremely hard material.

### CROSS REFERENCE TO RELATED APPLICATIONS

This application is a continuation of International Application No. PCT/EP2016/075451 filed Oct. 21, 2016, which designated the United States, and claims the benefit under 35 USC § 119(a)-(d) of German Application No. 10 2015 119 123.7 filed Nov. 6, 2015, the entireties of which are incorporated herein by reference.

### FIELD OF THE INVENTION

The present invention relates to a tool having a hard material for machining mineral and/or vegetable material layers, in particular, of traffic areas and/or agricultural land or combinations thereof with one another.

### BACKGROUND OF THE INVENTION

When developing or when renovating road surfaces by means of road milling machines, the tools used, in particular, the milling cutters, are exposed, for example, to a continuous wear process. Once the tools reach a certain state of wear, it is necessary to replace the tools as otherwise the further process will lose efficiency (effectiveness). The replacement of the milling cutters is cost-intensive on account of the necessary downtime of the milling machine and of the spare parts required.

US 2010/0263939 A1 discloses an impact-resistant tool which can also be used as milling cutters. In this case, a polycrystalline diamond body is connected to a hard metal substrate. The polycrystalline diamond body realizes a cutting point. It comprises great hardness, which results in extending the service life of the cutting point compared to a non-coated hard metal cutting point.

U.S. Pat. No. 4,604,106 describes a composite material having polycrystalline diamonds, which can be used as a protective layer for tool surfaces which are subject to serious mechanical stress. The polycrystalline diamonds comprise a higher level of impact resistance compared to a monocrystalline diamond. The size of the diamond particles present is between 1 to 100 μm.

DE 39 26 627 A1 describes a cutting tool with a shank and a cutting tool head in the form of a pick. A hard pin, for example, produced from fine-grained tungsten carbide, tantalum carbide or similar hard materials, forms the cutting point. This can be additionally diamond-coated. In addition, a wear protection layer, which is attached using a plasma powder deposition welding method, is additionally applied to the outer surface of the cutting tool head. A cutting tool holder for the cutting tool can also be coated with such a wear protection layer.

U.S. Pat. No. 6,245,312 B1 discloses a method for producing fullerite from fullerenes, for example, from the fullerene C₆₀. High pressures and high temperatures are necessary for this purpose. In dependence on the pressures and the temperatures during production, the fullerite comprises ultra-hardnesses of up to 170 GPa. It is consequently harder than natural diamond.

WO 2015/034399 A2 discloses a further method for producing fullerite from fullerenes, in particular, the fullerene C₆₀. In the case of the high-pressure methods provided here, an additive, in the present case carbon disulfide (CS₂), is added to the fullerene. The production of fullerite is effected in a diamond press where the upper punch is able to carry out a rotation in order to cause the material to shear. The method enables the production of fullerite at comparatively low pressures within the range of 8-10 GPa. The material obtained in this manner also exceeds the hardness of diamond.

### SUMMARY OF THE INVENTION

It is the object of the present invention to provide a hard material for a tool which comprises improved wear resistance compared to tools disclosed in the prior art.

The object is achieved as a result of at least part of the cutting element being formed and/or being covered with a hard material which includes fullerite or is formed from fullerite. Fullerite, on account of its specific crystal lattice construction, is ultra-hard, and this hardness is in excess of the hardness of diamond in dependence on the respective production method. A tool which comprises an extremely high level of wear resistance is obtained as a result. The service life of such a tool is able to be significantly extended compared to known tools as a result. This results in longer change intervals for the tools and consequently in lower spare part costs and shorter downtimes for the machine tool. When the tool, for example, a cutting tool of a road milling machine, is suitably designed, it can achieve a wear resistance which is within the range of the wear resistance of a tool holder, for example, a cutting tool holder on a milling drum. The tool equipped with fullerite can consequently be fixedly connected to the tool holder or realized in one piece with the tool holder, as a result of which a releasable connection is no longer absolutely necessary. For example, a cutting tool of a road milling machine can be realized fixedly or in one piece with the cutting tool holder which is arranged on a milling drum. As a result, the production costs for the entire system can be significantly reduced.

The service life of a tool can be extended, in particular, as a result of a tool head which carries the cutting element of the tool being covered at least in part by the hard material. During a machining process, for example, when milling a road surface, the cutting element, in particular, but also a tool head which connects directly to the cutting element, for example, a cutting tool head of a road milling cutting tool, is under severe mechanical stress. The wear on the components can be significantly reduced as a result of the covering of the cutting element and the tool head.

An extensive and at the same time cost-efficient coating of a tool surface or of part of a tool surface can be achieved as a result of the hard material being applied as a result of a coating process onto at least part of the cutting element and/or of the tool head.

Inherent forming of the hard material can be achieved by the hard material being applied as a result of a sintering process of a sintering material which includes fullerite. The forming is then effected by using a corresponding mold during the sintering process.

A preferred realization variant of the present invention is identified as a result of an intermediate material being arranged between the hard material and the cutting element and/or the tool head.

In this case, it can preferably be provided that the intermediate material provides a barrier for the diffusion of substances into or out of the hard material and/or that the intermediate material comprises a thermal expansion coefficient which lies between the expansion coefficient of the hard material and that of the cutting element and/or that of the tool head. The barrier can avoid substances from the tool surface diffusing into the hard material, as a result of which the fullerite converts partly into graphite by the diffusion of catalyzing iron. The hard material usually comprises a thermal expansion coefficient which significantly deviates from that of the region of the tool to be covered. During the joining process or when applying the hard material onto the tool, high temperatures are present in dependence on the process used. This results in high mechanical stresses between the tool and the hard material. Such stresses can result in the destruction or the loosening of the hard material. The mechanical stresses can be significantly reduced by adapting the expansion coefficient by means of the intermediate material.

Corresponding to a further embodiment of the present invention, it can be provided that the hard material covers a hard substance of the tool, in particular, a hard metal and/or a polycrystalline diamond. Thus, for example, the cutting element can be produced from a hard metal or a polycrystalline diamond, the high mechanical resistance of which can be significantly improved even more by the applied hard material.

If it is provided that the hard material covers a region of the tool formed from steel, the abrasion resistance of the cutting tool in the region can be significantly improved. Thus, for example, the service life of a tool head produced from steel, for example, a cutting tool head, can be adapted, as a result of the applied hard material, to the service life of a cutting element produced from a hard metal or a polycrystalline diamond, which is also covered by the hard material. This means that premature failure of the entire tool as a result of too much wear on the tool head is able to be avoided.

A particularly wear-resistant tool can be obtained as a result of the cutting element covering the tool head at least in regions. The cutting element thus protects the tool head from a high degree of wear.

In order to ensure a constantly high level of hardness of the hard material, it can be provided that the fullerite is formed from fullerenes, in particular, from fullerene C₆₀, as starting material.

In this case, the desired hardness can be achieved, in particular, as a result of the fullerite being formed under high pressure and/or at a high temperature and/or by the fullerite being formed as a result of adding a further substance, in particular, xylene or carbon disulfide.

A high load capacity of the tool can be achieved as a result of the fullerite comprising a hardness of greater than or equal to 130 GPa, in particular, greater than or equal to 170 GPa. The hardness of the fullerite is consequently in excess of that of a natural diamond, as a result of which a very high-level milling performance of the cutting tool can be achieved.

The maintenance intervals of a road milling machine can be extended and consequently the operating costs of the road milling machine reduced as a result of the tool being a cutting tool for a road milling machine, having a cutting tool head as a tool head which carries at least one cutting element, and having a coupling piece for connecting the cutting tool to a cutting tool holder or to another such base part.

### BRIEF DESCRIPTION OF THE DRAWINGS

The present invention is explained in more detail below by way of exemplary embodiments which are shown in the drawings, in which:

FIG. 1 shows a side representation of a cutting tool for a road milling machine, having a coupling piece which is realized as a cutting tool shank, a tool head which is realized as a cutting tool head and a cutting element;

FIGS. 2 to 5 show various embodiments of a cutting element for a cutting tool;

FIG. 6 shows a side representation, realized in part as a section, of a portion of a cutting tool head with a cutting element;

FIG. 7 shows a milling drum of a road milling machine;

FIG. 8 shows a side view of a cutting tool, namely a pick for a road milling machine which is inserted into the holder of a quick-change holder tool for such machines; and

FIG. 9 shows a side view of a cutting tool for a road milling machine which is fixedly connected to a cutting tool holder.

### DETAILED DESCRIPTION OF THE INVENTION

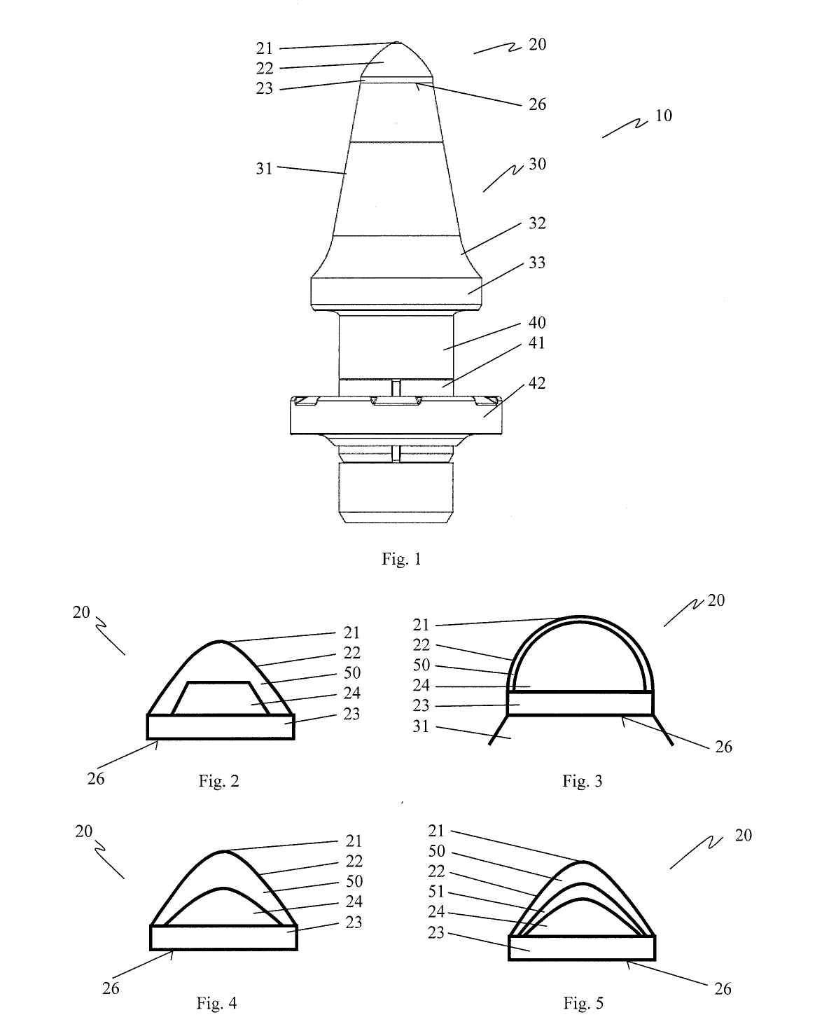

FIG. 1 shows a side representation of a cutting tool 10 for a road milling machine having a coupling piece 40, a tool head 30 tool head 30 which is realized as a cutting tool head and a cutting element 20. The cutting tool 10 acts as an exemplary embodiment representing a tool for machining mineral and/or vegetable material layers, in particular, of traffic areas and/or agricultural land or combinations thereof with one another.

The cutting tool 10 is realized as a pick. The tool head 30 has associated therewith a cutting element 20, consisting of a hard substance, for example, hard metal. This is connected to a base part 31 of the cutting tool head 13 which tapers conically toward the cutting element 20, in the present exemplary embodiment by soldering along a connecting surface 26. Proceeding from the cutting element 20, the tool head 30 widens over a transition region 32 to form a collar 33 with a constant external diameter. The collar merges in one piece into the coupling piece 40 which is realized as a cutting tool shank. The coupling piece 40 comprises, on its outer surface, an indentation (groove) for receiving a clamping sleeve 41 which is slotted in the axial direction. This is formed from a spring-elastic material, for example, steel plate. On account of the longitudinal slot, the fastening sleeve diameter is able to be varied, the sleeve edges having to be moved toward one another (small diameter) or being spaced further apart from one another (large sleeve diameter). Various clamping states can be achieved in this way. A wear protection disk 42 is pulled onto the clamping sleeve 41. The wear protection disk 42 holds the clamping sleeve 41 at a small diameter such that it is able to be inserted with little or no effort into a cutting tool receiving means 62 of a first cutting tool holder 60 shown in FIG. 8. The insertion movement is delimited by means of the wear protection disk 42. When the coupling piece 40 is inserted further into the bore, the wear protection disk 42 is moved into a region of the coupling piece 40 not included by the clamping sleeve 42. The clamping sleeve 41 then springs open radially and expands in the cutting tool receiving means 62 of the first cutting tool holder 60. In this way, the cutting tool 10 is held so as to be axially captive, but freely rotatable in the circumferential direction. As shown further in FIG. 1, the wear protection disk 42, aligned toward the tool head 30, realizes a support surface for supporting the collar 33 of the tool head 30.

The cutting element 20, proceeding from a front cutting point 21, comprises a convexly formed cutting surface 22 which merges into a base 23. In dependence on the milling task to be carried out, arbitrary other forms of the cutting element 20 and of the tool head 30 are possible.

For use, the cutting tool 10 is mounted on the first cutting tool holder 60 shown in FIG. 8 so as to be rotatable about its center longitudinal axis and installed on a rotating drum carrier. As a result of the rotation of the drum carrier, the cutting element 20 penetrates into the material to be removed, for example, asphalt or soil, and shreds it. The excavated material slides past the tool head 30 and, in this case, is deflected outward by the base part 31 and the transition region 32. The first cutting tool carrier 60, in which the cutting tool 10 is held, is thus protected from wear by the excavated material.

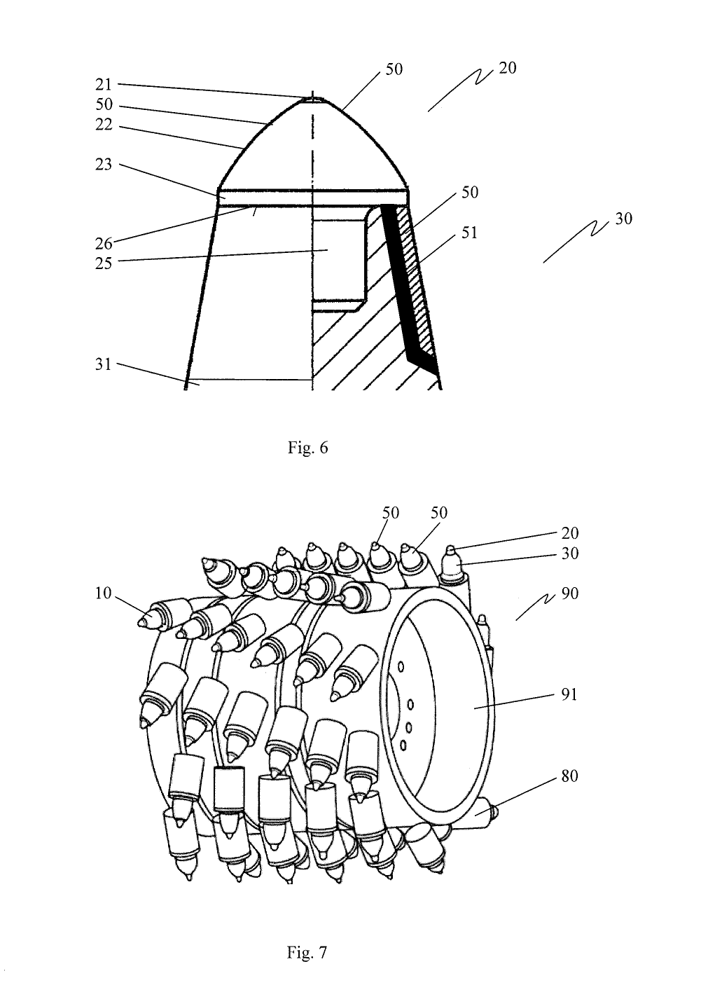

The cutting element 20 is produced from a hard substance, in the present exemplary embodiment from hard metal. The mechanical load on the tool head 30 is greatest in the region of the cutting element 20. The base part 31 of the tool head 30, in particular, directly connected to the cutting element 20, is also subject to a very high mechanical load. According to the present invention, the cutting element 20, as can be seen in FIG. 6, is consequently covered with a hard material 50, coated in the present case. The region of the base part 31 of the tool head 30 facing the cutting element is also coated with such a hard material 50.

The hard material 50 includes fullerite or is totally constructed from fullerite. The fullerite is produced from fullerenes. Fullerenes are spherical molecules produced from carbon atoms. Under high pressure and where applicable high temperatures, fullerenes can be arranged and connected in a tetrahedral crystal structure. The corners of the tetrahedral crystal structure of the fullerite are therefore occupied by the spherical molecules or by fragments of the spherical molecules of the fullerenes used. The basic structure of the crystals corresponds to that of a diamond. A nanocrystalline powder is obtained as the end product of such a production process. The hardness of the fullerite produced in this manner is in excess of the hardness of diamond in dependence on the chosen production process and production parameters and for example can be 170 GPa. Additional additives, for example, xylene or carbon disulfide, can be added during the production process. Such additives, as well as the process parameters, in particular, the level of the necessary pressure and the necessary temperature during the production thereof, are able to influence the characteristics of the fullerite obtained.

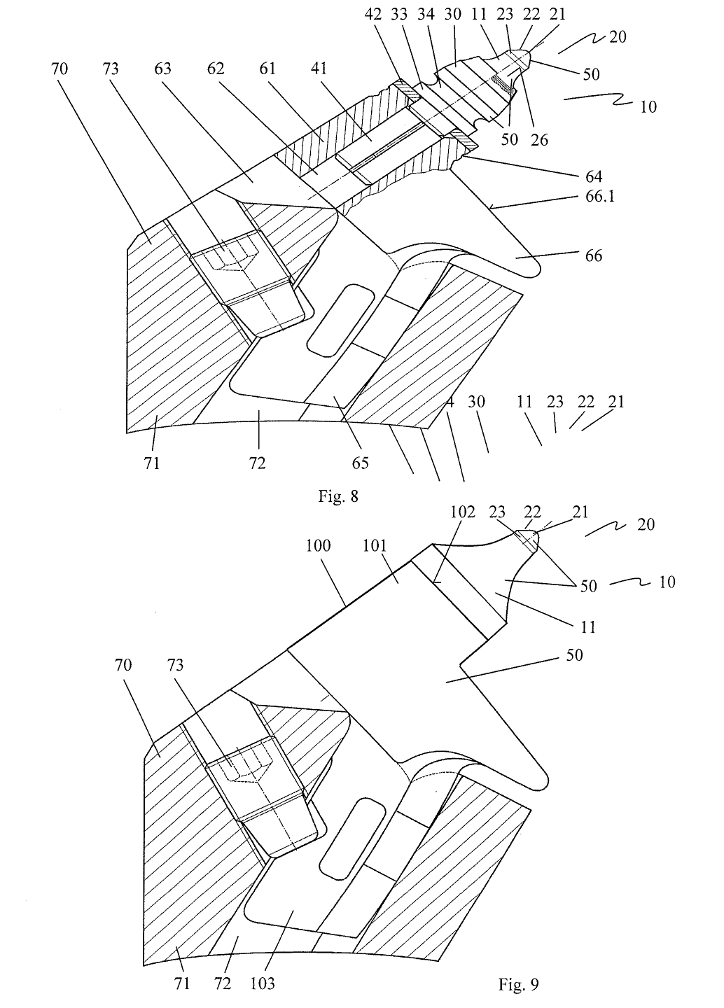

As a result of the ultra-hardness of the hard material 50 obtained in this way, the load capacity and consequently the service life of the tool, in the present exemplary embodiment of the cutting tool 10, are able to be increased significantly. In this case, in particular, the coating of the cutting element 20, which is under serious mechanical stress, with the cutting point 21 and the cutting surfaces 22 results in an increase in the life expectancy of the cutting tool 10 according to the present invention compared to known cutting tools. As a result of an at least partial coating of the tool head 30 with the hard material 50 directly connected to the cutting element 20, it is also possible to increase its service life significantly and consequently to adapt it to the service life of the coated cutting element 20. Further parts of the cutting tool head can preferably be covered by the hard material 50. For example, the complete base part 31 or the transition region 32 can thus be protected by the hard material 50. The excavated material is thus directed past a subsequent first and second cutting tool holder 60, 80 shown in FIGS. 7 and 8 as a result of the abrasion-resistant form of the tool head 30. Consequently, the hard material 50 applied on the cutting tool 10 also covers part of the respective cutting tool holder 60, 80, as a result of which the wear on the cutting tool holder 60, 80 is significantly reduced.

FIGS. 2 to 5 show, as an example, various embodiments of the cutting element 20 for a cutting tool 10. In the case of the exemplary embodiment shown in FIG. 2, a trapezoidal attachment 24 is connected in one piece to the base 23. The attachment 24 and the region of the base 23 extending around it are covered by the hard material 50 and are connected to it. In this case, the hard material 50 is formed in such a manner that it realizes the cutting point 21 and the cutting surface 22 on the surface. The base 23 and the attachment 24 are formed by a hard substance, in the present exemplary embodiment by hard metal. The hard material 50 comprises its greatest thickness in the region of the cutting tip 21 under the greatest mechanical stress. As a result, a cutting element 20 with a particularly long-life expectancy is obtained. The hard material 50 is fixed laterally by the attachment 24. The measures avoid the hard material 50 coming loose from the base 23 and from the attachment 24 even in the case of high shear forces. The hard material 50 closes off in an advantageous manner laterally with the base 23 so that the excavated material is steered past the base 23. As a result of the ultra-hardness of the hard material 50 which includes fullerite or is constructed from fullerite, the cutting element 20 formed in this manner is extremely wear resistant.

In the case of the exemplary embodiment shown in FIG. 3, the attachment 24 is realized in the form of a hemisphere. The attachment 24 and the base 23 are connected together in one piece. In this case, the attachment 24 and the base 23 are produced from a polycrystalline diamond in the exemplary embodiment shown. The attachment 24 is coated with the hard material 50 which includes fullerite or is formed from fullerite. As a result of the coating, the abrasion resistance of the cutting element 20 can be increased compared to a cutting element 20 produced completely from polycrystalline diamond, as the hard material 50 comprises a greater hardness than polycrystalline diamond. The hard material 50 advantageously closes off laterally with the base 23 so that the excavated material is guided past the base 23. Corresponding to a further embodiment of the present invention which is not shown, it can be provided that the base 23 is also covered laterally by the hard material 50.

FIG. 4 shows a further possible embodiment of the cutting element 20. The attachment 24 which is connected to the base 23, in this case, is realized such that it already predefines the outer contour of the cutting element 20 with its cutting point 21 and the cutting surface 22. The hard material 50 covers the attachment 24 and the circumferential region of the base 23. In this case, it realizes the cutting point 21 and the cutting surface 22 which slopes downward in a strengthened manner in relation to the attachment 24. As a result of the shaping of the attachment 24, sharp edges are avoided on the boundary to the comparatively brittle hard material 50. Stress peaks, as can appear on such sharp edges, are excluded as a result.

The exemplary embodiment of a cutting element 20 shown in FIG. 5 comprises a base 23 and an attachment 24 as well as an outer contour of the cutting point 21 and of the cutting surface 22 comparable to the exemplary embodiment shown in FIG. 4. The base 23 and the attachment 24 are produced from hard metal. Deviating from the example shown in FIG. 4, an intermediate material 51 is arranged between the attachment 24 and the hard material layer 50. The intermediate layer 51 comprises a thermal expansion coefficient which lies between that of the hard material 50 and the material of the base 23 and of the attachment 24. The hard material 50 usually comprises a thermal expansion coefficient which deviates from the base 23 and the attachment 24. As a result, where the base 23 and the attachment 24 are directly connected to the hard material 50, as is shown in FIG. 4, high mechanical stresses occur in the adjacent materials in the case of temperature changes. High temperature changes occur, for example, during the manufacturing process of the cutting element 20, but also during the milling process. The stresses can result in the hard material 50 tearing or flaking from the attachment 24 and the base 23. By adapting the thermal expansion coefficient by means of the intermediate material 51, stress peaks in the adjoining materials can be at least reduced. As a result, destruction of the hard material 50 during temperature changes is avoided. The intermediate material 51 can comprise, for example, a construction comparable to the hard material 50 with a proportion of fullerite that deviates therefrom and consequently also with ultra-hardness.

FIG. 6 shows, in a lateral representation which is realized in part as a section, a portion of a tool head 30 with the cutting element 20. In this case, the tool head 30 is shown unilaterally in a sectional representation.

The cutting element 20 comprises a fastening portion 25 which is fixed into a corresponding recess of the base part 31 of the tool head 30. The fastening portion 25 is connected in one piece to the base 23 of the cutting element 20 and in the present exemplary embodiment is realized in a cylindrical manner. The base 23 lies with its connecting surface 26 circumferentially to the fastening portion 25 on the base part 31 of the tool head 30. The base part 31 and the cutting element 20 are connected together, for example by soldering. The cutting element 20 produced from hard metal is coated with hard material 50. Even the region of the base part 31 facing the cutting element 20 comprises a coating with the hard material 50. An intermediate layer produced from an intermediate material 51 is arranged between the hard material 50 and the base part 31. The base part 31 is produced from steel. The intermediate material 51 forms a diffusion barrier between the steel of the base part 31 and the hard material 50. This avoids catalyzing iron atoms diffusing into the hard material and breaking down the fullerite there.

The cutting element 20, which is covered with hard material 50, advantageously covers the end faces of the intermediate material 51 and hard material 50 applied on the base part 31, which end faces are open toward the cutting element 20. This avoids excavated material passing into the region of the intermediate material 51 and degrading it.

FIG. 7 shows a milling drum 90 of a road milling machine (not shown) as a possible area of application for a tool provided with the hard material 50. Two cutting tool holders 80 are welded in a circumferential manner on a milling roller tube 91. Cutting tools 20 are fixed on the second cutting tool holders 80. In this case, the cutting tool heads 30 project with the attached cutting elements 20 out of the second cutting tool holders 80. The cutting tool heads 30 are produced from steel, whilst the cutting elements 20 are produced from a hard substance, in the present exemplary embodiment from hard metal. Both the cutting tool heads 30 and the cutting elements 20 are covered by the hard material 50. Consequently, the cutting tools 10 achieve a service life which corresponds to that of the second cutting tool holder 80. The cutting tools 10 thus do not have to be replaced prematurely. Consequently, they do not have to be realized so as to be releasable from the second cutting tool holders 80 but can be fixedly connected to them. As a result, the design of the second cutting tool holder 80 and of the coupling piece 40 of the cutting tool 10 is significantly simplified, as a result of which the production costs of the second cutting tool holder 80 and of the cutting tool 10 are decisively reduced.

FIG. 8 shows, as an example, a cutting tool 10, as is known, uncoated, in the prior art and is described, as an example, in DE 38 18 213 A1. The cutting tool 10 comprises a tool head 30 and a cutting tool shank which is integrally molded thereon in one piece as a coupling piece 40. The tool head 30 carries a cutting tool point 11, consisting of a hard substance, for example, of hard metal. The cutting element 20 provides the frontmost portion of the cutting tool point 11.

The cutting tool point 11 is usually soldered to the tool head 30 along a contact surface. A circumferential extraction groove 34 is worked into the cutting tool head 12. This serves as a tool receiving means in such a manner that a releasing tool is able to be fitted and the cutting tool 10 released from the first cutting tool holder 60.

As is also shown in FIG. 1, the coupling piece 40 carries a cylindrical clamping sleeve 41 which is longitudinally slotted. The clamping sleeve is captive in the direction of the longitudinal extension of the cutting tool 10 but is held on the coupling piece 40 so as to be freely rotatable in the circumferential direction. The wear protection disk 42 is arranged in the region between the clamping sleeve 41 and the tool head 30. In the assembled state, the wear protection disk 20 is supported on a counter surface of the first cutting tool holder 60 and on the underside of the tool head 30 remote from the first cutting tool holder 60.

The first cutting tool holder 60 is fitted with an attachment 61 into which is worked a cutting tool receiving means 62 in the form of a cylindrical bore. In the cutting tool receiving means 62, the clamping sleeve 41 is held in a clamped manner with its outer periphery against the bore inside wall. The cutting tool receiving means 62 opens out into an ejection opening 63. An ejection mandrel (not shown) can be introduced through the ejection opening for the purpose of releasing the cutting tool 10. The ejection mandrel acts in such a manner on the end of the coupling piece 40 that, by overcoming the clamping force of the clamping sleeve 41, the cutting tool 10 is pushed out of the cutting tool receiving means 62.

As can be seen in FIG. 8, the attachment 61 is provided with two circumferential grooves in a cylindrical region below the wear protection disk 42. The grooves serve as wear markings 64. In operation, the wear protection disk 42 rotates and, in this case, can bring about wear (cutting tool holder wear) on the support surface of the attachment 61. When the support surface has been worked so far that the second wear marking is reached, the first cutting tool holder 60 is deemed to be worn to such an extent that it has to be replaced.

The first cutting tool holder 60 comprises a plug attachment 65 which is introducible into a plug receiving means 72 of a base part 70 of the shown cutting tool holder changing system and can be clamped there by means of a clamping screw 73.

The base part 70 itself, not shown further in FIG. 8, is welded onto the milling drum tube of a milling drum via its underside 71.

In the case of such a cutting tool holder changing system according to the prior art, the cutting tool 10 wears more quickly than the first cutting tool holder 60. Consequently, the cutting tools 10 have to be changed significantly more frequently than the cutting tool holders 60. According to the present invention, at least the cutting element 20, preferably the entire outer surface of the cutting tool point 11, is consequently covered with the hard material 50. It is also particularly advantageous for the tool head 30 also to be covered by the hard material 50. As a result of the ultra-hardness of the hard material 50, which includes fullerite or is constructed from fullerite, both the cutting tool point 11 and the tool head 30 have a service life that is significantly extended compared to the known non-coated cutting tools. As a result, the change intervals of the cutting tools 10 can be extended in a considerable manner and the maintenance-related downtimes of the road milling machine significantly reduced. Corresponding to a further embodiment of the present invention (not shown), the first cutting tool holder 60 also comprises, at least in regions, a coating with the hard material 50. This can be arranged in an advantageous manner in the region of the attachment 61 or on an abrasion surface 66.1 of a shielding region 66 which covers part of the base part 70.

FIG. 9 shows a side view of a cutting tool 10 for a road milling machine which is fixedly connected to a third cutting tool holder 100.

The cutting tool 10 with the third cutting tool holder 100 consequently provides a direct further development of the cutting tool holder changing system shown in FIG. 8, as is made possible by the hard material 50. The cutting tool point 11 is connected directly and releasably to an attachment 101 of the third cutting tool holder 100. In the exemplary embodiment shown, this is effected by a corresponding soldered connection along a connecting surface 102 between the cutting tool point 11 and the attachment 100. The cutting tool point 11 is formed from a hard substance, in the present case hard metal. As an alternative to this, it is also possible to use other hard substances, for example, polycrystalline diamonds. The cutting tool point 11 is coated with the hard material 50. In this case, the hard material 50 comprises its greatest thickness in the region of the cutting point 21. The third cutting tool holder 100 is preferably also covered at least in part by hard material 50.

As a result of the hard material 50, the service life of the cutting tool point 11 is extended in such a manner that it is preferably adapted to the service life of the third cutting tool holder 100. The cutting tool 10 formed by the cutting tool point 11 does not therefore have to be changed more frequently than the third cutting tool holder 100. Consequently, the wear-related maintenance intervals can be significantly extended, and, with that, the operating costs of the road milling machine correspondingly reduced. On account of the high level of mechanical resistance of the cutting tool point 11, which is protected with the hard material 50, the wear thereof is reduced so much that a rotatable bearing arrangement about its center longitudinal axis is no longer necessary. It is thus possible to dispense with a costly releasable and rotatable fastening mechanism between the cutting tool 10 and the cutting tool holder 60, 80, 100, as shown in the realization in FIG. 8. As a result, the entire design of the cutting tool holding arrangement is significantly simplified.

As a result of the coating of the third cutting tool holder 100 with the hard material 50, the load capacity thereof is also significantly improved. As a result of the hard material 50, the service life of the third cutting tool holder 100 is able to be adapted to the service life of the base part 70. Corresponding to a realization variant (not shown) of the present invention, it is then no longer necessary to connect the third cutting tool holder 100 releasably to the base part 70. Cutting tool point 11, cutting tool holder 100 and base part 70 can thus be realized connected to one another in a fixed and non-releasable manner. In an advantageous manner, the cutting tool holder 100 and the base part 70 are then able to be produced in one piece.

1. A tool with at least one cutting element for machining mineral and/or vegetable material layers,
wherein at least part of the cutting element is formed and/or is covered with a hard material which includes fullerite or is formed from fullerite.

2. The tool as claimed in claim 1, wherein a tool head, which carries the cutting element, of the tool is covered at least in part by the hard material.

3. The tool as claimed in claim 1, wherein the hard material is applied as a result of a coating process onto at least part of the cutting element and/or of the tool head.

4. The tool as claimed in claim 1, wherein the hard material is applied as a result of a sintering process of a sintering material which includes fullerite.

5. The tool as claimed in claim 1, further comprising an intermediate material arranged between the hard material and the cutting element and/or the tool head.

6. The tool as claimed in claim 5, wherein the intermediate material provides a barrier for the diffusion of substances into or out of the hard material and/or wherein the intermediate material comprises a thermal expansion coefficient which lies between the expansion coefficient of the hard material and that of the cutting element and/or that of the tool head.

7. The tool as claimed in claim 1, wherein the hard material covers a hard substance of the tool.

8. The tool as claimed in claim 1, wherein the hard material covers a region of the tool formed from steel.

9. The tool as claimed in claim 1, wherein the cutting element covers the tool head at least in regions.

10. The tool as claimed in claim 1, wherein the fullerite is formed by fullerene as starting material.

11. The tool as claimed in claim 1, wherein the fullerite is formed under high pressure and/or at a high temperature and/or wherein the fullerite is formed as a result of adding a further substance.

12. The tool as claimed in claim 1, wherein the fullerite comprises a hardness of greater than or equal to 130 GPa.

13. The tool as claimed in claim 1, wherein the tool is a cutting tool for a road milling machine, having a cutting tool head as a tool head which carries at least one cutting element and having a coupling piece for connecting the cutting tool to a cutting tool holder or to another such base part.

14. The tool as claimed in claim 7, wherein the hard substance is a hard metal and/or polycrystalline diamond.

15. The tool as claimed in claim 10, wherein the fullerene is fullerene C₆₀.

16. The tool as claimed in claim 11, wherein the further substance is xylene or carbon disulfide.

17. The tool as claimed in claim 12, wherein the fullerite comprises a hardness of greater than or equal to 170 GPa.
